(19) United States
(12) Patent Application Publication
(10) Pub. No.: US 2026/0172133 A1
(43) Pub. Date: Jun. 18, 2026

(54) Adaptive One Way Time Transfer Method of Precision Time Synchronization

(71) Applicant: Riverside Research Institute, Beavercreek, OH (US)

(72) Inventors: Joshua J. White, Beavercreek, OH (US); Phillip R. Van Hooser, Chillicothe, OH (US); Ganesh R. Basawapatna, Beavercreek, OH (US)

(21) Appl. No.: 18/978,520

(22) Filed: Dec. 12, 2024

Related U.S. Application Data
(60) Provisional application No. 63/608,931, filed on Dec. 12, 2023.

(51) Int. Cl. H04J 3/06

(52) U.S. Cl. CPC H04J 3/0667; H04J 3/0664; H04J 3/0697

(57) ABSTRACT

An adaptive and predictive precision time synchronization system and method for time synchronization between at least two clocks, wherein the method includes generating a reference clock and a periodic Time Marker Pulse by a Leader, embedding or modulating the TMP, a Leader Time Stamp and a leader position as a leader package in a reference clock signal, and encrypting and transmitting the reference clock signal via broadcast to at least one Follower. The at least one Follower down converting the signal, receiving the leader package in the reference signal, and performing signal processing and error correction, demodulating or de-embedding the reference signal and extracting the TMP from the received signal, creating a Follower time stamp within the at least one Follower, phase locking a clock oscillator in the at least one Follower to the reference clock, calculating and predicting time correction and applying the time correction creating a follower corrected time stamp, calculating timing signal transit time between the at least one Follower and the Leader clock, selecting a chosen number of pulses, calculating a predicted expected value of the leader clock based on the chosen number of pulses, transmitting the predicted expected value to the Leader, comparing the predicted expected value of the leader clock with an actual leader time clock value after the chosen number of pulses and creating and storing a clock correction; and sending the clock correction to the at least one follower for a correction term.

This application claims priority to U.S. Provisional Patent Application No. 63/608,931, filed Dec. 12, 2023, entitled “AN ADAPTIVE CLOSED LOOP METHOD OF PRECISION TIME SYNCHRONIZATION” and is hereby incorporated by reference herein.

The present invention provides a system and method for near real time closed loop correction of the time error between multiple clocks.

### BACKGROUND

The present invention is an improvement to the existing art for refining the time synchronization process both to verify its accuracy, and to create a method for predictive and adaptive second order corrections.

When the need arises for clocks in multiple bodies that are separated from each other in space and possibly moving in different directions to all be showing the exact same time so that their actions can be coordinated, some very critical problems arise. The first, is that every clock has a certain amount of timing inaccuracy that is a function of its temperature and other internal and environmental factors. These are typically called drift when describing short term variations, and holdover when describing total inaccuracy over a defined, usually long time period. In addition, from the theory of relativity, any clock in motion counts time at a different rate than the same clock at rest.

Most modern clocks derive their time from the outputs of stable usually sinusoidal reference oscillators. These oscillators get their stability from crystal resonators or cesium or rubidium based ultra-stable resonators. The higher the stability the larger the cost, size and weight of the reference. Given these factors, and the fact that no matter the cost, there always exist drift and holdover, it becomes necessary in many systems to find methods where one stable clock acts as the Master or Leader, and the other clocks in the system, usually called Slaves or Followers, are made to synchronize to this Leader.

The accuracy with which a Follower needs to follow a Leader depends upon the application. To time the arrivals and departures of trains at a railway station, an accuracy of seconds is more than enough. To time financial transactions in modern stock markets presently, the aim is to get microseconds of accuracy. In the CERN Large Hadron Collider, the impulses provided each accelerator node need sub-nanosecond accuracy. It is envisaged that when high frequency electromagnetic pulses are used, for example, to coherently target an enemy radar, the accuracy needed may be picoseconds or even lower.

The process of synchronization typically consists of the Leader clock sending its reference clock frequency, a periodic Time Marker Pulse (TMP), and an associated time stamp to a follower, which attempts to synchronize its clock to the Leader by means of a phase lock loop and adjusting its time clock so that it has the same epoch, defined by a reference start of time, as the Leader. The transmission times between Leader and Follower, the amount of time it takes for the electronics in each to process the reference signals, and the temperatures, mutual velocities and accelerations all affect this process, and need to be corrected to achieve the desired precision level.

At present there exist protocols such as the Precision Time Protocol (PTP, or IEEE 1588) and White Rabbit (WR) that attempt to achieve this by employing Two Way Time Transfer (TWTT) synchronization with appropriate signals in both directions. Two Way Time Transfer (TWTT) as it is done with the IEEE1588 Precision Time Protocol, or the White Rabbit (WR) process of CERN, may not be possible or practical in systems with multiple non-stationary assets. There are many reasons for this. Since most IEEE1588 and WR applications are fixed and stationary, two-way measurements that are done a-periodically often suffice since none of the distances between the elements changes, except for temperature dependence. Military missions on the other hand can be highly dynamic where the distances between the bodies is changing unpredictably and hence the elapsed time between forward and subsequent backward transmissions could be appreciably different. TWTT operates by averaging the forward and reverse transmission times between a Leader and a Follower. This would be meaningless if both elements are moving unpredictably at high speeds.

Also, TWTT systems typically define multiple levels of clocks. Thus, while there is only one Master Clock, additional clocks called Transparent Clocks and Boundary Clocks are defined that are phase locked to the Master with sufficient precision, whose main function is to distribute the Master clock more efficiently. This is possible since all the elements of the systems are static and defined in relation to each other and there are defined lines of communications that allow distributed clock dissemination. Missions that are highly dynamic with multiple assets whose relation to each other and tasks on any mission is defined centrally by a Command Control and Communications asset management system cannot assume such static relation between elements. Mission critical functions such as time dissemination often cannot be done except centrally. In Global Positioning System (GPS) or other similar systems operating in degraded or denied environments, the selection of the reference clock often needs to be centrally defined and redefined as elements are added and removed. Finally, the best TWTT results to date are of sub nanosecond accuracy. Many future warfare systems need picosecond or sub-picosecond accuracy.

In modern operations which might include elements with a range of mobilities from dismounted individuals to hypersonic weapons, the precision required between subsets of elements may need to be field defined in real time. The reference clock itself may need to be dynamically re-assigned if the existing reference is made not available by enemy action.

The problem can be summarized as follows. In most modern Electronic Warfare systems with multiple elements in relative motion, it is often necessary that these elements are synchronized to a Leader. The degree to which each particular element is synchronized in terms of fractions of a second depends among other items upon the function of the element in the mission, and the size, weight, power and cost (SWaP-C) to achieve the level desired. Often these systems are a combination of assets that are employed ad hoc. Thus, there is no practical way to assign levels of Masters, Transfer Clocks, and Grand Masters. In a communications dense atmosphere, it would be best to achieve the different levels of synchronization needed in each element without the need for two-way time transfer. A flexible, adaptive solution is needed, which allows one way transmission of clock data from one Leader to multiple followers, each of which may have different levels of synchronization accuracy. A flexible and open solution is needed.

### SUMMARY OF THE INVENTION

The present invention overcomes the disadvantages of systems such as the IEEE1588 protocol and the White Rabbit system of CERN which require recalibration if there are any path length changes between any two elements of the system, which requires taking part of the system or often the entire system offline to perform re-calibration. Such a solution can ultimately allow realization of almost perfect time synchronization between the clocks of two bodies when they are static, and within the limitations of computational speed, when they are in relative motion. It is extendable to multiple bodies in relative motion.

In such scenarios, the most efficient and practical method would be to have one way clock synchronization. In one way clock synchronization or its extension One Way Time Transfer (OWTT) the Leader broadcasts its clock signal, TMP and associated time stamp periodically to all elements of the system, and each element, according to the accuracy it needs, synchronizes its own clock waveform and time to match the Leader at the level needed. This is a broadcast one-way process. However, often there is value to having closed loop correction in time synchronization. It allows for the verification of precision for each element and allows for second-order or fine-tuned correction where additional precision is needed. That is what present invention makes possible. The present invention provides Closed Loop synchronization that has more power than traditional two-way time transfer and prior art in dynamic situations. It also allows correction for nondeterminism in processing time in the various elements of the system.

The present invention provides a One-Way Coherent Time Transfer using an algorithm where the system, based upon past information, predicts the time of arrival of the next TMP and plots the error in prediction versus pulse number and extrapolates for the next correction term. The system is adaptive in that the correction algorithm in terms of relative weights on the nondeterministic factors can be modified to achieve a convergence to an acceptable error level.

Another embodiment of the invention provides a Closed Loop Solution predicting the value of a future “f” pulses, hence value of the Leader Time Code LTC(f), sends it to the Leader, and generates a correction term for that particular follower. The follower corrects its algorithm based upon this information. This approach works well in systems that do not have too many elements and where two-way transmission was available.

Another embodiment of the present invention provides an Enhanced Closed Loop solution allowing all the corrections to be made in the follower using optimal prediction techniques without involving reverse transmissions to the Leader. This has the advantage that each Follower element can set its own acceptable synchronization accuracy based upon size, weight, power and cost considerations.

Another embodiment of the present invention provides a separate dedicated Clock channel for truly coherent performance as the Follower clocks will always be syntonized (frequency locked) to the Leader and be able to phase adjust to achieve much more accurate phase synchronization.

The present invention provides An adaptive and predictive precision time synchronization system and method for time synchronization between at least two clocks, wherein the method includes generating a reference clock and a periodic Time Marker Pulse by a Leader, embedding or modulating the TMP, a Leader Time Stamp and a leader position as a leader package in a reference clock signal, and encrypting and transmitting the reference clock signal via broadcast to at least one Follower. The at least one Follower down converting the signal, receiving the leader package in the reference signal, and performing signal processing and error correction, demodulating or de-embedding the reference signal and extracting the TMP from the received signal, creating a Follower time stamp within the at least one Follower, phase locking a clock oscillator in the at least one Follower to the reference clock, calculating and predicting time correction and applying the time correction creating a follower corrected time stamp, calculating timing signal transit time between the at least one Follower and the Leader clock, selecting a chosen number of pulses, calculating a predicted expected value of the leader clock based on the chosen number of pulses, transmitting the predicted expected value to the Leader, comparing the predicted expected value of the leader clock with an actual leader time clock value after the chosen number of pulses and creating and storing a clock correction; and sending the clock correction to the at least one follower for a correction term.

The present invention also provides a near real time adaptive and predictive precision time synchronization system for time synchronization between at least two clocks, wherein the system includes a Leader, wherein the Leader includes a leader clock and a leader transmitter module, at least one Follower, wherein the at least one Follower includes a follower clock to be synchronized to the Leader clock and a command, control and communications receiver module receiving transmissions from the leader transmitter module, a clock oscillator located in the Follower, follower synchronization circuitry, a time correction module, a leader time prediction module, and a time comparison module.

The present invention allows the creation of a system where a Leader distributes its Clock and its time to all Followers simultaneously, and each Follower, based upon its timing needs, uses the appropriate level of time synchronization.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 shows the elements involved in a typical military mission with C5ISR;

FIG. 2 shows the steps involved in One Way Time Transfer of the present invention;

FIG. 3 shows a flow chart showing further detail for the Leader in One Way Time Transfer of the present invention;

FIG. 4 shows a process flow chart for a portion of the One-Way Time Transfer of the of the present invention shown in FIG. 2; and

FIG. 5 shows an exemplary flowchart of a closed loop method of the present invention.

### DETAILED DESCRIPTION OF THE INVENTION

At the outset it should be stated that all the embodiments described herein are exemplary. There are many other ways by which each of the described functions can be realized, however, for the purposes of describing the invention one or more exemplary embodiments have been chosen. This in no way should be construed to restrict the applicability of the patent and should allow other function realization methods and concepts to be employed.

A definition of terms and associated caveat would be worthwhile here. When the clock oscillator of a Follower is at the exact same frequency as that of the Leader, frequency locked, it is said to be Syntonized to the Leader. If the Follower clock is at the same phase as the Leader, it is said to be Synchronized to the Leader. However, synchronization does not imply that the clocks in both Leader and Follower show the exact same time. There could still be an integral number of cycles difference between Leader and Follower. To correct this, the Leader and Follower clocks need to be made identical at the start of the mission. This is not practical in most missions. If all the clocks in the system follow a common time epoch, for example UTC, their clocks would not still be identical, but as long as the two bodies are synchronized, this error will be a constant. In systems such as beam forming, the clocks do not matter, but the phases do. Therefore, a clock difference will not matter. In time-based systems, such as coordinated action, so long as the instructions are based on “x seconds hence”, i.e., relative to the “present” instant, the lack of clock exactness is not a problem. This invention, by providing a method for syntonization and synchronization, provides such a solution.

The present invention provides an Adaptive and Predictive Precision Time Synchronization System and Method including a Leader (which may be called Master or other name), a Follower (which may be called Slave or other name), a group of circuits, software and firmware modules within the Follower, and a Leader Time Prediction module.

The Leader generates an accurate and periodic Time Marker Pulse (TMP) embedded or modulated into a Reference Clock signal, with an associated Time Code, and also, when available the Co-ordinate Position, Velocity Vector, and Acceleration Vector information of the Leader, herein called the INU package, which all lumped together are herein called the Leader Time Code Package (LTCP). The LTCP is transmitted via broadcast to multiple Followers with the aim of all the Follower's Clocks and Time, to as accurately as needed, synchronize with the Leader's Clock and Time. The Leader Time Code Package is incorporated in with other Command, Control, and Communications packages generated in the Leader and broadcast to multiple followers with appropriate encryption and frequency translation.

The Follower, which is a part of a group of a number of such Followers, each simultaneously receive the timing signal after its Command, Control, and Communications receiver module receives the transmission from the Leader Transmitter module, down converts, and performs various signal processing and error correction functions, extracts the Leader Time Code Package to be sent to the Follower synchronization circuitry along with a Follower INU data package which consists of the Followers Position, velocity vector and acceleration vector parameters.

A group of circuits and software and firmware modules, within each Follower, demodulate or de-embed the TMP from the received signal, immediately create a Follower Time Stamp, simultaneously Phase Locks the Clock oscillator resident in the Follower to the Reference Clock signal sent by the Leader, and inputs the Leader and Follower Timing Pulses and the Leader Time Code, the Follower Time stamp and the Follower INU parameters all associated with that particular Leader Time Package to a Time Correction Module (TCM) for processing and Time Correction. The Time Correction Module receives and stores all the above data pertaining to each TMP labeled with an ID unique to each TMP, uses multiple algorithms to calculate and predict an open loop Time Correction to be applied to the Follower Time Stamp so that it more accurately calculates the correct time in relation to the Leader Time Code and the actual elapsed time between the generation of the Leader Time Code and the Follower Time Stamp. The TCM applies the correction so that the Follower Time Stamp is more accurate and minimizes the effect of the jitter and noise-based errors in the process. The Time Correction Module also creates a predicted value of the corrected Follower Time Pulse corresponding to the next TMP that will arrive, and when that next TMP arrives, calculates a next correction term that can be used by the algorithm to predict the next Follower Time Stamp more accurately.

A Leader Time Prediction Module (LTPM), predicts, by extrapolating the Follower Corrected Time Stamp and the projected transit time between the Leader and the Follower, the expected value of the Leader Time Clock after a certain chosen number of TMP pulses, and sends this data along with the number of pulses chosen, M, back to the Leader. The Time Comparison Module in the Leader compares the Predicted Leader Time Stamp after M TMP pulses with the actual Leader Time Clock after M pulses and creates a Clock Correction that it stores in its own memory and sends back to the appropriate Follower so that the Follower now has a Closed Loop Correction Term that is adaptively adjustable by the value of M selected. The value of M is selected to minimize the correction needed and the averaging and predictive algorithms are continuously refined with the aim of minimizing the correction.

An embodiment of the present invention includes some or all of the followers operating strictly in an open loop correction mode based on the level of synchronization needed; some or all of the Followers operating in a Closed Loop fashion by predicting future streams of predicted Leader Times and correcting their predictions and calculating trends in order to achieve lower synchronization errors; or, the entire closed loop operation occurring within each Follower to create an Enhanced Closed Loop System where the Leader time stamp prediction is compared with actual data within the Follower and appropriate correction made.

### Description of the Open Loop Solution

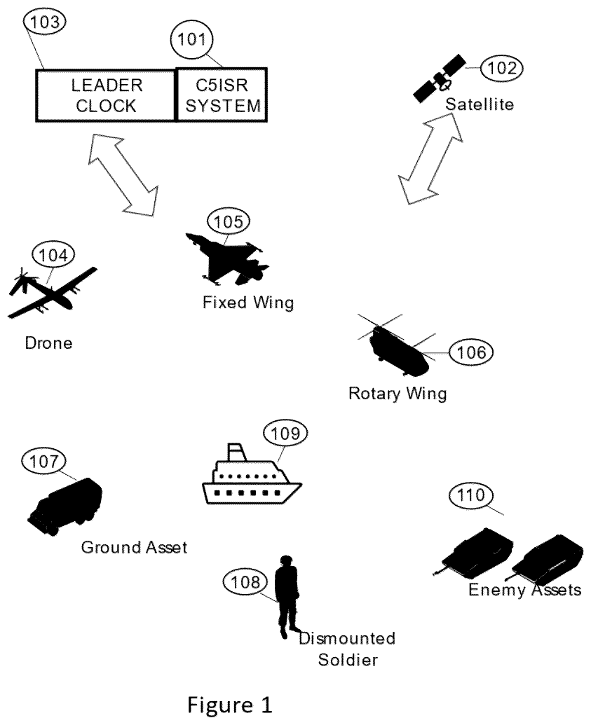

FIG. 1 shows an example of the elements involved in a typical mission with Command, Controls, Communications, Computers and Cyber Intelligence, Surveillance and Reconnaissance usually called C5ISR control. In this figure, 101 represents the C5ISR system. Leader Clock 103 gets its reference from one of a number of possible reference sources, herein represented by GPS satellite 102. The elements that derive their time from Leader Clock 103 may include Drones 104, fixed wing aircraft 105, rotary wing aircrafts 106, ground assets 107, naval assets 109, and dismounted soldiers 108. All these elements attempt to align their clocks to Leader 103 to varying degrees of precision based upon their roles. Also in the field are enemy assets 110.

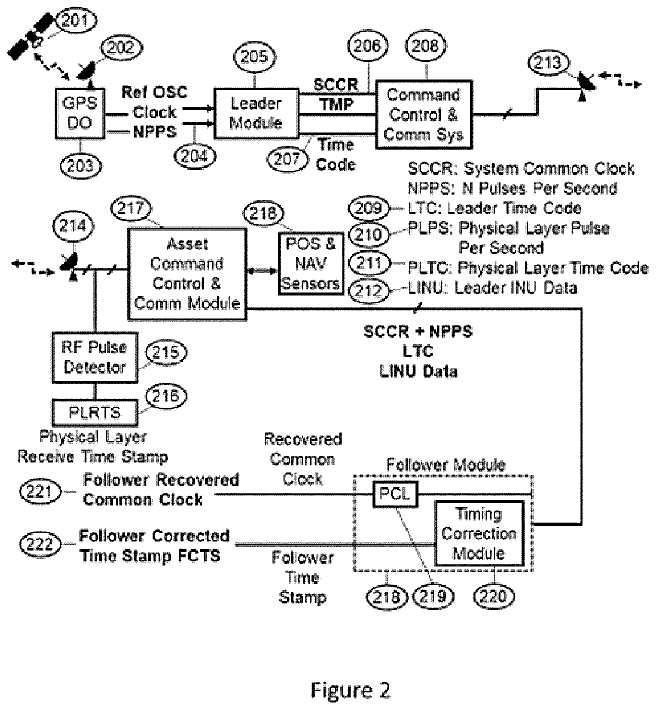

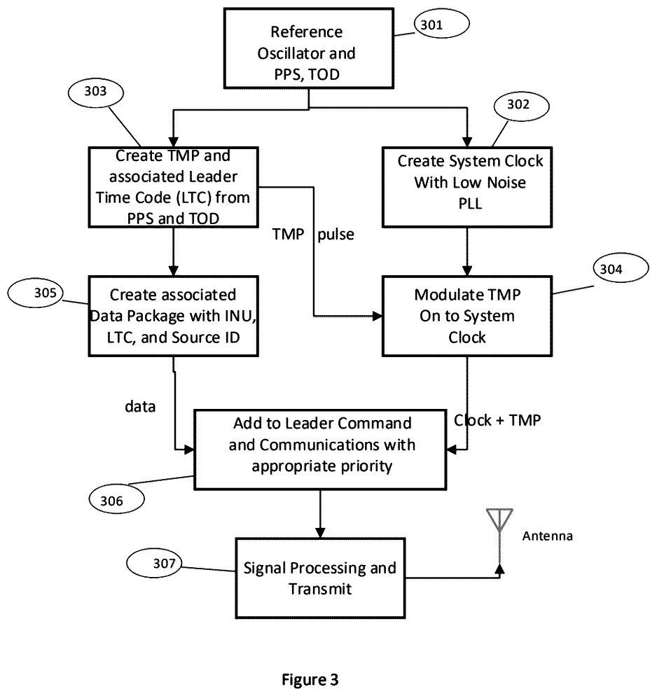

A method for One Way Coherent Time Transfer (OWCTT) is described in exemplary fashion below and refers to FIG. 2 and the corresponding flow chart in FIG. 3.

Leader 103 either has access to GPS signal 201 received via antenna 202 to drive its GPS Disciplined Oscillator (GPSDO) 203 or has a very accurate and very low drift and low holdover Chip Scale Atomic Clock (CSAC) or rubidium oscillator internally that acts as a reference. This is also called the Reference Oscillator (RO), 301 in FIG. 3.

The RO output—whether derived from the GPS or other reference signal, e.g. US Naval Observatory (USNO) reference broadcast, also includes an accurate Time Marker Pulse (TMP) train which typically is a N Pulses Per Second (NPPS) pulse 204, typically a few nanoseconds wide where N is an integer, often 1, and an associated Time of Day (TOD) data packet, which typically is typically tied to the Coordinated Universal Time known as UTC. All these are fed into Leader, 205. The Leader Module 205 receives outputs of 203 and generates and outputs System Common Clock Reference and TMPs 206. Associated with each TMP is a UTC related Time Code 207 (also often called a Time Stamp) called herein the Leader Time Code (LTC). Outputs 206 and 207 of the Leader Module 205 are input to the Command and Control systems circuitry 208, where they are also encrypted, upconverted and power amplified and fed to the typically omnidirectional antenna 213, so that all the receivers that are part of the mission can receive the signals.

This process is described in greater detail in the process flow chart in FIG. 3. Here the reference oscillator (RO) is generated in 301 from the system GPS or from the US Naval Observatory (USNO) clock or other alternative Position Navigation and Timing (alt-PNT) reference. The associated Time Code and TMP pulse are generated in 303, and the Leader Clock is created in 302 using Digital and Analog Phase Lock Loops. The TMP is modulated onto the System Clock output of 302 in Modulator 304, whose output is the system clock with the TMP pulse modulated on to it. This waveform is sent to the Leader Command and Communications module 306 to be processed and broadcast to all mission elements. At the same time a data package is created in block 305 with the Leader Time Code LTC associated with the TMP, and position based upon the Inertial Navigation Unit (INU) parameter information and Source ID of the mission element are created and sent to the Leader Command and Communications module block 306. The Leader Command and Communications module 306 then combines these data and waveforms with system commands and communications and sends it to the Signal Processing and Transmit module 307, to be encrypted, upconverted and amplified to be then sent to the antenna to be broadcast to all mission elements.

What is described above is one possible example of the signal processing. The functions could be achieved in many other ways to realize the same combination of clock and timing related waveforms for broadcast. The final result is that periodically, the Leader broadcasts a clock waveform, a Time Marker Pulse, and an associated Leader Time code, together called the Leader Clock-Time Packet (LCTP).

We now describe in exemplary fashion how one of the Followers receives and processes the LCTP so that its clock and time are best synchronized with the Leader. Referring to FIG. 2, antenna 214 receives the LCTP package along with Command and Control Communications from the Leader. The Follower optionally has a pulse detector 215 and time stamp generator 216 so that the arrival time of a physical layer time stamp 211 can be recorded. The output of antenna 214 is fed to the Asset Command, Control and Communications Module, 217. This module performs many functions. It down converts the incoming RF signal and performs receiver signal processing functions such as Doppler and Multipath correction and Forward Error Correction. These processes often are computation intensive and recursive, and as a result the amount of time that it takes to process such signals cannot be defined exactly. This signal processing time is nondeterministic. In many systems, block 217 may also receive the Inertial Navigation Unit data of the Follower's position, velocity and acceleration vectors 224. When the transmitted signals are recovered at the end of this process, they are parsed and distributed to various mission sensors and elements. Timing and INU related data 209, 210, 211, 212, if available, are sent to the Follower module 218 for processing. Follower Module 218 has a demodulator which recovers the TMP associated with the LTC that was sent, and the RO, which is used to Phase Lock the Follower Timing Clock to the Leader Reference Clock in module 219. At the same time a Time Correction Module 220 employs methods to account for all the time that passed between when the LTC was generated and when it was received using algorithms that calculate all the nondeterministic signal processing times and signal transit times to high accuracy, minimizing non-determinism. These result in the Follower Recovered Time Clock 221, which assures that time stamps close to that TMP will be more accurate, and Follower Corrected Time Stamp 222, which assures that the UTC time shown in the Follower is within acceptable error limits to the time at the same instant at the Leader. That is, that the Leader and Follower are time synchronized to within acceptable range.

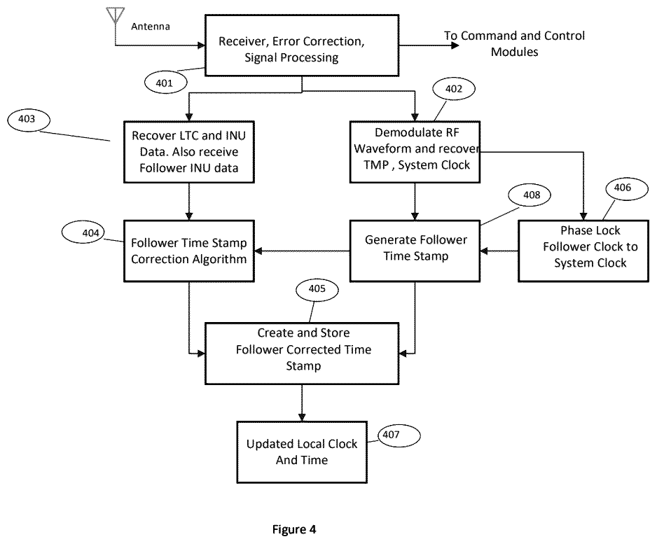

Processing Flow Chart of FIG. 4 describes the process shown in this part of FIG. 2. Here 401 represents the Receiver including Low Noise Amplifier, Downconverter, and the Doppler, Multipath, and Forward Error Correction processes and the Signal Processing and parsing to allow each sensor and element in the receiver to receive its information or command. The Timing Module receives the LCTP signal consisting of the waveform with embedded TMP and the associated LTC data. Block 402 represents the functions of demodulation to extract the TMP and sending the clock information to the Phase Lock Loop 406 so the Follower system clock is corrected to follow the Leader clock. The closer these two clocks are aligned, the less correction of time that will be needed. The Follower Time Stamp is generated and stored in 407. At the same time both the Leader and the follower INU data are processed in block 403. The Follower Time Stamp correction algorithm, as shown in block 404, corrects the Follower Time Stamp by correcting for the INU parameters and by using filtering and prediction such as Kalman filtering and prediction techniques to estimate the nondeterministic time in both the Leader and the Follower. In 405, the Follower Corrected Time Stamp is generated and in 408 results in updated Clock and Time data in the Follower.

The Timing Correction Module, 220, uses the previous time stamp data and averaging and filtering techniques such as Kalman filtering, to minimize the non-determinism, noise and jitter related errors and to smooth out the noise terms to create a Follower Corrected Time Stamp 222, the best estimate of what the Follower Time Clock Time should be. This is shown in Flow chart blocks 405 and 407.

The same format is followed every time a Time Code (in the Leader) or a Time Stamp or a modified Time Stamp (in any Follower) is created. A Time Data Packet (TDP) as shown in 305, is created with, at the minimum the following attributes: a TMP pulse which is not a part of the TDP packet, but it is associated with a particular TDP packet; a Time Code, Time Stamp, or modified/derived Time Stamp/Code associated with that TMP pulse; assurance that the clock waveforms will be in phase lock, the TMP pulse is modulated on to the System Clock in 103; a source ID which is an identifier that defines where it originated (what Follower, for example, created it) and what TMP pulse it is associated with; and if available an INU or positional, velocity and acceleration parameters related to the Leader and the Follower in question at that point in time.

The TMP pulse needs to be identified by a pulse number, such as the hour portion of the TOD plus the number of the pulses for that hour. For example, if there are 10 pulses per second, i.e., 36,000 pulses per hour, at 4 pm UTC, the 22,346^{th} pulse would be 1600:22346 (or as 1637:146, as would be in traditional UTC clocks) in decimal notation. This data packet, based upon the system, may be appended with other elements such as preambles and other identifiers and data packet encapsulation. It may also be encrypted. The Follower Time Code correction is continuously updated by predicting the next clock value corresponding to the next TMP pulse and comparing it with the actual one.

### Description of the Closed Loop Solution

While the above is indeed a very powerful method for One Way time synchronization, the basic fact is that each Follower in such a system is still operating in an open loop fashion. That is, there is no built-in check as to whether the corrections for any Follower is accurate or not. A closed loop method to verify operation and create correction parameters would make the system stronger. For this reason, in the past, systems used and still use Two-way Time Transfer methods. However, these Two-Way methods only worked for static systems as they made the corrections by averaging the two-way transfer times. In a dynamic system this is almost always guaranteed to give erroneous results. Also, many systems of the kind under consideration do not allow for continuous Two-Way transfer, because the primary purpose is command and control, and not time correction.

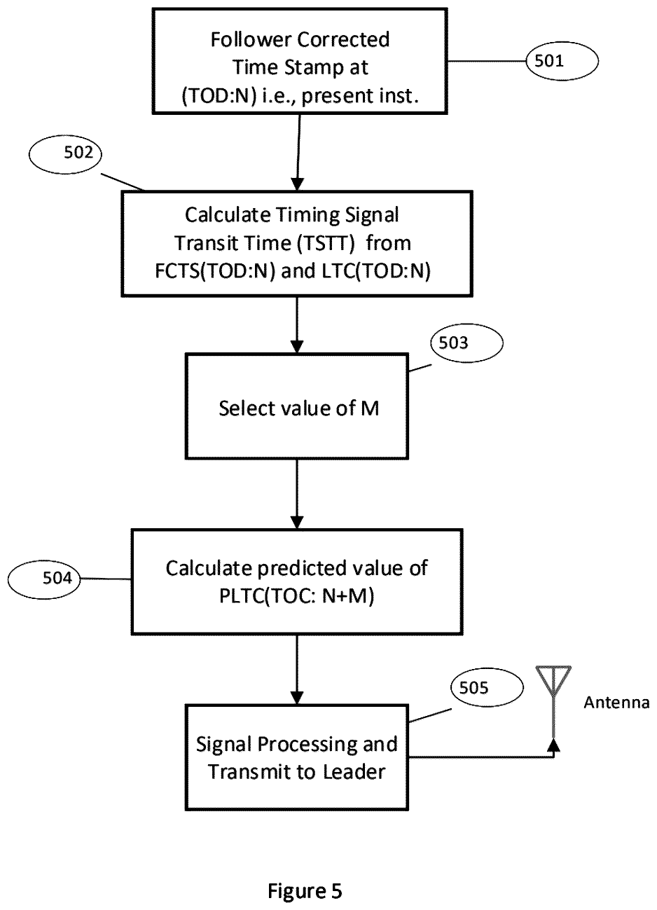

The present invention provides a Closed Loop system and method as follows and is shown in the flow chart in FIG. 5.

The Follower Corrected Time Stamp (FCTS) 222 is the Follower's best estimate of the actual time, based upon the system clock at that instant. In other words, if there existed a method of measuring the time at the same instant in both the Leader and the Follower based upon FCTS, they would both be identical. However, such a measurement is impractical, and if made practical would be very costly and not applicable to most of the mission elements under consideration.

The present invention resolves this problem. The FCTS and the Follower Clock shown in 501 are used to predict the value of the Leader Time Clock (LTC) for some future value of time, for example “M” TMP pulses from the present measurement, where M is an integer. If FCTS were truly precisely equal to LTC, then the predicted value of FCTS M pulses would be the same value as the actual LTC M pulses hence.

We define p=present TMP pulse number. Then, ideally, there would be no nondeterminism, and,

$$FCTS ( p ) = LTC ( p ) + X ( p )$$

where X(p) is the actual transit and signal processing time of TMP pulse p between when it was generated at the Leader, and when it was received at the Follower.

Since FCTS(p) and LTC(p) are known to the Follower, the value of X(p) can be calculated by subtraction and stored versus p in a table in the memory of the Follower. Further, by using the stored values of X(p) versus p, an extrapolation for a future pulse value f, M pulses hence, i.e., f=p+M, can be calculated. For this future value of f, the predicted value of LTC, PLTC, would be

$$PLTC ( f ) - FCTS ( f ) - X ( f )$$

Where FCTS(f) and X(f) are projected or calculated values at TMP pulse identified by “f”. These process steps are shown in 502, 503 and 504 flow chart elements in FIG. 5.

The calculated value of PLTC(f) along with the identifying TMP pulse “f” is transmitted back to the Leader as shown in element 505. Since this is a future predicted value, if M is properly chosen, it can arrive and be available at the Leader before the actual LTC(f) is generated. When LTC(f) is generated, the Leader can calculate the error

$$E ( f ) = PLTC ( f ) - LTC ( f )$$

which is then transmitted to the Follower as an additional correction term for the FCTS generating algorithm. The new corrected PLTC(f) would be given by

$${PLTC ( F )}_{CORRECTED} = LTC ( f ) + E ( f )$$

Two observations can be made. First, it is not necessary to do this for every TMP pulse. How often this is repeated can be adaptively determined by plotting E(f) versus f. If E(f) is increasing versus f, then the periodicity of the correction may need to be reduced, and if it is decreasing, then the periodicity can be increased. This process can be made adaptive. Second, the value of M can be chosen based upon the particular element and based upon predictive algorithms. Where time precision is not critical both M and the periodicity can tend to open loop, whereas for time critical elements a more optimum set of values can be adaptively calculated.

In the present invention, both the Leader, which has stored E(f) as a function of f and the Follower, which has the same, have a very accurate measure of the precision of the synchronization process.

The advantages over traditional TWTT methods are significant. There is no need to send TMP pulses back to the Leader. As already described, these will only make the errors worse in dynamic systems.

The value of M can be chosen in real time on the basis of the Follower or mission/applications. If the Follower is a dismounted soldier M can be large, since there is almost no need to do closed loop. On the other hand, if the Follower is a fighter aircraft, M may need to be made much smaller to act like real time closed loop. It can be different for different assets within the same operation. If M is selected to be very small, the system is closed loop in near real time. If it is made very large, the system is effectively Open Loop.

### Description of the Enhanced Closed Loop Solution (ECL)

The Enhanced Closed Loop (ECL) process is based upon the observation that the Follower has already made the prediction of PLTC(f). All that is needed is for the Follower to wait for pulse f to actually arrive at the Follower and compare the received Actual Leader Time ALT(f) and calculate the correction;

$$E ( f ) = PLTC ( f ) - ALT ( f )$$

This has the advantage of not involving the Leader in any calculations or data transmission, and yet arriving at the exact same closed loop correction term. Thus, effectively creating all the advantages of a Closed Loop solution in an Open Loop System without two-way time transfer.

### Dedicated Clock Distribution Solution

Another embodiment provides a dedicated RF Clock path available between Leaders and Followers for time synchronization. In such a case element 208, 217, and 218 in FIG. 2 do not contain any signal processing or C5ISR data handling. This will drastically minimize the non-determinism associated with signal processing both in the Leader and in the Follower. The Follower may be directly phase locked to the Leader clock signal, with a phase adjustment in each Follower made by TMP based Clock Corrections of the above-described methods.

We claim:

1. An adaptive and predictive precision time synchronization method for time synchronization between at least two clocks, wherein the method comprises:
generating a reference clock and a periodic Time Marker Pulse (TMP) by a Leader;
embedding or modulating the TMP, a Leader Time Stamp and a leader position as a leader package in a reference clock signal;
encrypting and transmitting the reference clock signal via broadcast to at least one Follower;
the at least one Follower down converting the signal, receiving the leader package in the refence signal, and performing signal processing and error correction;
demodulating or de-embedding the reference signal and extracting the TMP from the received signal;
creating a Follower time stamp within the at least one Follower;
phase locking a clock oscillator in the at least one Follower to the reference clock;
calculating and predicting time correction and applying the time correction creating a follower corrected time stamp;
calculating timing signal transit time between the at least one Follower and the Leader clock;
selecting a chosen number of pulses;
calculating a predicted expected value of the leader clock based on the chosen number of pulses;
transmitting the predicted expected value to the Leader;
comparing the predicted expected value of the leader clock with an actual leader time clock value after the chosen number of pulses and creating and storing a clock correction; and
sending the clock correction to the at least one follower for a correction term.

2. The method as recited in claim 1, wherein the at least one Follower operates in an open loop correction mode without transmission back to the leader.

3. The method as recited in claim 1, wherein the at least one Follower operates in a Closed Loop.

4. The method as recited in claim 3, wherein the at least one Follower receiving the reference clock signal operates in an Enhanced Closed Loop, wherein the Closed Loop predictions and error correction are performed entirely by the Follower without transmission back to the Leader.

5. The method as recited in claim 1, wherein the leader clock package is broadcast to the at least one Follower on a separate clock channel.

6. The method as recited in claim 1, wherein the leader position includes Co-ordinate Position, Velocity Vector, and Acceleration Vector information.

7. The method as recited in claim 1, wherein the data associated with the leader package includes leader clock TMP, a follower clock TMP, a leader time code, a follower clock time stamp and follower clock INU parameters.

8. A near real time adaptive and predictive precision time synchronization system for time synchronization between at least two clocks, wherein the system comprises:
a Leader, wherein the Leader includes a leader clock and a leader transmitter module;
at least one Follower, wherein the at least one Follower includes a follower clock to be synchronized to the Leader clock and a command, control and communications receiver module receiving transmissions from the leader transmitter module;
a clock oscillator located in the Follower;
follower synchronization circuitry;
a time correction module;
a leader time prediction module; and
a time comparison module.
